(19) United States
(12) Patent Application Publication
(10) Pub. No.: US 2026/0145917 A1
(43) Pub. Date: May 28, 2026

(54) CRANE

(71) Applicant: SUMITOMO HEAVY INDUSTRIES CONSTRUCTION CRANES CO., LTD., Tokyo (JP)

(72) Inventors: Tatsuya MATSUSHITA, Obu-shi (JP); Toshiki OE, Obu-shi (JP)

(21) Appl. No.: 19/455,167

(22) Filed: Jan. 21, 2026

Related U.S. Application Data
(63) Continuation of application No. PCT/JP2024/027503, filed on Aug. 1, 2024.

(30) Foreign Application Priority Data
Aug. 2, 2023 (JP) 2023-125925

(51) Int. Cl. B66C 23/36; B66C 23/88; H04N 7/18; H04N 23/90

(52) U.S. Cl. CPC B66C 23/365; B66C 23/88; B66C 2700/0371; H04N 7/18; H04N 23/90

(57) ABSTRACT

A crane includes a counterweight, an upper structure behind which the counterweight is disposed, in which a transport posture width of a transported configuration including the upper structure is smaller than a width of the counterweight, and at least two side cameras that image a left-right direction from the upper structure, in which the two side cameras are disposed at a first position on a left side and a first position on a right side, respectively, outside a range of the transport posture width, and the two side cameras are changeable in disposition to a second position on the left side and a second position on the right side, respectively, which are different from the first position on the left side and the first position on the right side.

### CROSS-REFERENCE TO RELATED APPLICATIONS

This is a bypass continuation of International PCT Application No. PCT/JP2024/027503, filed on Aug. 1, 2024, which claims priority to Japanese Patent Application No. 2023-125925, filed on Aug. 2, 2023, which are incorporated by reference herein in their entirety.

### BACKGROUND

### Technical Field

Certain embodiments relate to a crane.

### Description of Related Art

The related art discloses a crane including a plurality of cameras that image surroundings of a vehicle body. In the crane, a large number of cameras are required in order to reduce a blind spot.

### SUMMARY

One or more embodiments provide a crane including a counterweight, an upper structure behind which the counterweight is disposed, in which a transport posture width of a transported configuration including the upper structure is smaller than a width of the counterweight, and at least two side cameras that image a left-right direction from the upper structure, in which the two side cameras are disposed at a first position on a left side and a first position on a right side, respectively, outside a range of the transport posture width.

### BRIEF DESCRIPTION OF THE DRAWINGS

FIG. 1A is a perspective view showing a crane, according to a first embodiment.

FIG. 1B is a front view showing the crane, according to the first embodiment.

FIG. 1C is a plan view showing the crane, according to the first embodiment.

FIG. 2 is a block diagram showing a periphery monitoring device mounted on the crane, according to the first embodiment.

FIG. 3A is a perspective view showing a transported configuration of the crane, according to the first embodiment.

FIG. 3B is a front view showing the transported configuration of the crane, according to the first embodiment.

FIG. 3C is a plan view showing the transported configuration of the crane, according to the first embodiment.

FIG. 4A is a view for describing a blind spot viewed from the front in the first embodiment and a comparative example.

FIG. 4B is a view for describing the blind spot viewed from the front in the first embodiment and the comparative example.

FIG. 4C is a view for describing the blind spot viewed from above in the first embodiment and the comparative example.

FIG. 4D is a view for describing the blind spot viewed from above in the first embodiment and the comparative example.

FIG. 5 is a view showing an example of a bird's-eye view image synthesized from images from a plurality of cameras including the two side cameras.

FIG. 6 is a view for describing an example of setting a first position when an overhang amount of a counterweight is different.

FIG. 7A is a perspective view showing a crane, according to a second embodiment.

FIG. 7B is a front view showing a transported configuration of the crane, according to the second embodiment.

FIG. 8A is a perspective view showing a crane, according to a third embodiment.

FIG. 8B is a front view showing a transported configuration of the crane, according to the third embodiment.

FIG. 9A is a perspective view showing a crane, according to a fourth embodiment.

FIG. 9B is a front view showing the crane, according to the fourth embodiment.

FIG. 10A is a perspective view showing a transported configuration of the crane, according to the fourth embodiment.

FIG. 10B is a front view showing the transported configuration of the crane, according to the fourth embodiment.

### DETAILED DESCRIPTION

There are cranes having various features such as a crane on which a counterweight having a narrow width is mounted and a crane on which a counterweight having a wide width is mounted. In a crane on which the counterweight having a wide width is mounted, a specific blind spot is likely to be generated when the surroundings are imaged. It has been examined whether it is possible to efficiently acquire an image of the surroundings by disposing the cameras according to the features of the crane.

With the present invention, in the crane in which the width of the counterweight is larger than the transport posture width of the transported configuration including the upper structure, it is possible to efficiently acquire, by the two side cameras, an image of surroundings with a smaller blind spot.

Hereinafter, each of embodiments of the present invention will be described in detail with reference to the drawings.

### First Embodiment

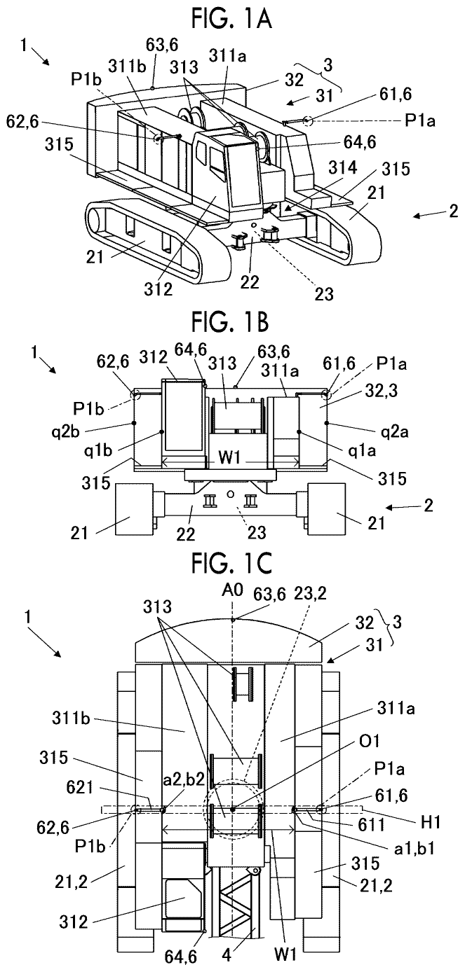

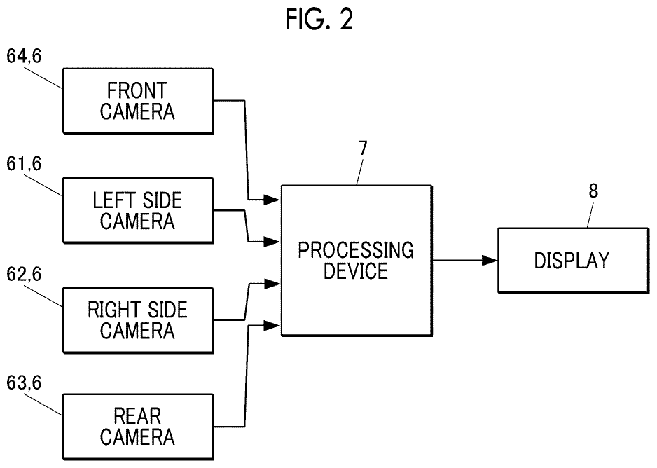

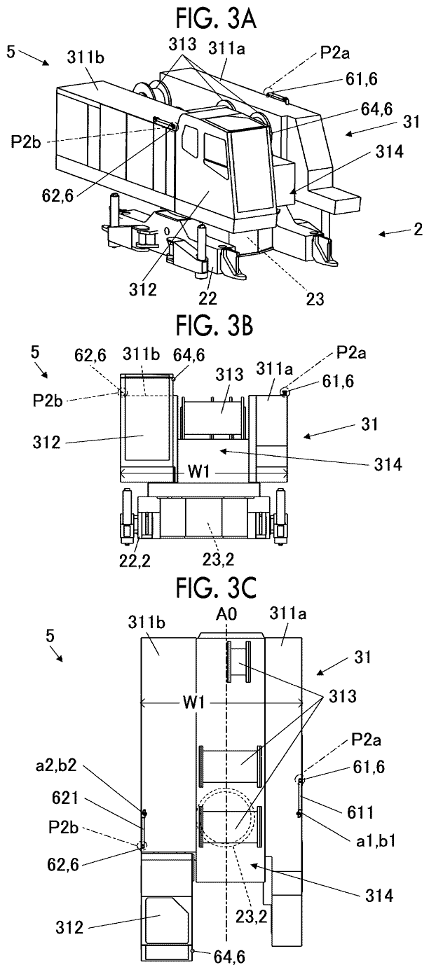

FIGS. 1A to 1C are a perspective view, a front view, and a plan view showing a crane according to the first embodiment of the present invention. FIG. 2 is a block diagram showing a periphery monitoring device mounted on the crane according to the first embodiment of the present invention. FIGS. 3A to 3C are a perspective view, a front view, and a plan view showing a transported configuration of the crane according to the first embodiment of the present invention. In FIG. 1, illustration of some components to be described later is omitted.

A crane 1 of the first embodiment of the present invention is a self-traveling crawler crane as shown in FIGS. 1A to 1C and includes a lower traveling body 2 that is capable of traveling and a rotating platform 3 that is provided to be capable of rotating with respect to the lower traveling body 2. The rotating platform 3 includes an upper structure 31 and a counterweight 32 disposed behind the upper structure 31. Although a part thereof is omitted in the drawing, the crane 1 further includes a boom 4 (see FIG. 1C) and a mast that are assembled to the rotating platform 3 to be derricked, a hanging tool hung by the boom 4, and a wire rope that is configured to be wound and unwound by a winch 313. The illustration of the boom 4 is omitted except for FIG. 1C.

The lower traveling body 2 includes an undercarriage 21 such as a crawler, a frame 22 that supports the undercarriage 21, and a rotating portion 23 that supports the rotating platform 3 to be rotatable. When a front surface of the rotating platform 3 is directed toward a straight traveling direction of the undercarriage 21, a width of the undercarriage 21 is wider than a width of the rotating platform 3.

The upper structure 31 includes machine rooms 311a and 311b, a cab 312, the winch 313, a boom support 314 that pivotably supports the boom, a mast support (not shown) that pivotably supports the mast, a counterweight mounter (not shown) on which the counterweight 32 is mounted, and a catwalk 315 that is a scaffold for a worker to walk on.

The crane 1 is disassembled into a plurality of transported configurations and is transported by a trailer or the like and is assembled on site. As shown in FIG. 3A, one transported configuration 5 includes the upper structure 31, the frame 22 of the lower traveling body 2, and the rotating portion 23. In a transport posture, the catwalk 315 of the upper structure 31 included in the transported configuration 5 is folded or removed. A transport posture width W1 of the transported configuration 5 is smaller than a width of the counterweight 32. The transport posture width W1 means a width of a configuration during transport. Specifically, the transport posture width W1 means a width during transport for each of the plurality of transported configurations that are disassembled from each other. The width means a maximum dimension in a direction along a width direction of a transport machine when placed on a transport machine such as a trailer. An orientation in which the transported configuration is placed on the transport machine is defined as an orientation described in a user manual or the like. In a case where the above description is not made, the width is defined as a maximum dimension in a transverse direction in plan view.

The transported configuration 5 of the present embodiment is designed such that the transport posture width W1 is close to the maximum width (a “maximum width −0.1 m” to a maximum width or the like) determined by regulations related to transport when traveling on a public road while being placed on the trailer or the like, such as 3 m. In this manner, generally, the transport posture width W1 of the transported configuration of the crane is restricted in terms of design by the regulations related to transport when traveling on a public road or the like while being placed on the trailer or the like. That is, the transport posture width W1 is at most the same as the maximum width specified by legal regulations related to transport when traveling on a public road or the like while being placed on the trailer or the like. The transport posture width W1 of the transported configuration 5 does not need to have a length close to the maximum width and may have any length, but is a length set in advance in the user manual or the like depending on a model.

The transport posture width W1 of the transported configuration 5 corresponds to a length in a left-right direction from a left end of a left machine room 311a to a right end of a right machine room 311b. Alternatively, the transport posture width W1 of the transported configuration 5 corresponds to a length in the left-right direction from the left end of the left machine room 311a to a right end of the cab 312. Alternatively, the transport posture width W1 of the transported configuration 5 corresponds to the length of the frame 22 of the lower traveling body 2 in the left-right direction. The length in the left-right direction means the length of a left-right direction component, and, for example, in a case where the positions of the left end and the right end are shifted in a front-rear direction or an up-down direction, the length in the left-right direction means the length of the left-right direction component of a line segment, instead of the length of a line segment connecting the left end and the right end.

### Periphery Monitoring Device

The crane 1 includes the periphery monitoring device for monitoring a periphery of a machine body, as shown in FIG. 2. The periphery monitoring device includes a plurality of cameras 6 that image the periphery of the machine body, a processing device 7 that captures images from the plurality of cameras 6 to generate an image for surroundings monitoring, and a display 8 that outputs the image for surroundings monitoring generated by the processing device 7. The display 8 may be provided in the cab 312, may be provided in a management room separated from the crane 1, or may be a portable tablet terminal or the like.

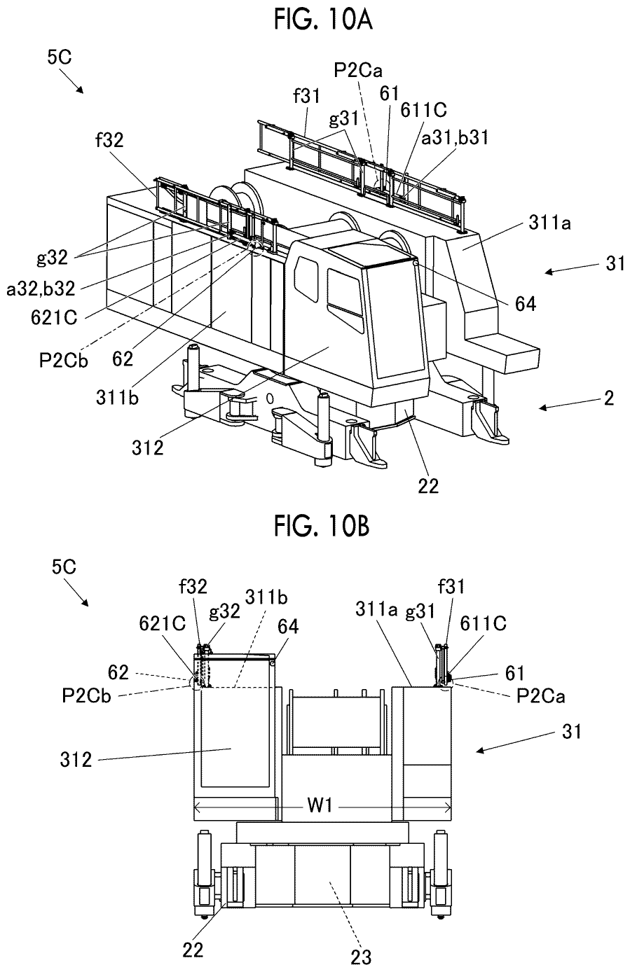

The plurality of cameras 6 include a pair of left and right side cameras 61 and 62. The plurality of cameras 6 may further include a rear camera 63 that images the rear and a front camera 64 that images the front. The rear camera 63 is disposed, for example, at a central rear end or the like of an upper portion of the counterweight 32. The front camera 64 is disposed in front of the upper structure 31. The front camera 64 is provided on an outer frame of glass in front of the cab 312. More specifically, the front camera 64 is disposed toward the center of the upper structure 31 and above the cab 312 when viewed from the front of the cab 312. In addition, as shown in FIG. 10A, the cab 312 protrudes forward in a lower portion more than in an upper portion. In other words, the lower the glass in front of the cab 312 is, the further forward it is positioned. Accordingly, the front camera 64 is provided behind a portion of the cab 312 that is positioned furthest forward. Accordingly, the front camera 64 does not affect the dimension of the entire upper structure 31 in the front-rear direction. The front camera 64 may be provided in front of the portion of the cab 312 that is positioned furthest forward. The front camera 64 may be provided to protrude from the portion of the cab 312 that is positioned furthest forward. In a case where the front camera 64 protrudes forward from the portion of the cab 312 that is positioned furthest forward, the front camera can image a lower front side without being obstructed by the lower portion of the cab 312 overhanging forward. The front camera 64 can easily image the lower front side of the upper structure 31 insofar as the front camera 64 protrudes forward from at least a glass portion of the cab 312. The front, the rear, the left, and the right mean the front, the rear, the left, and the right when a direction in which a fallen boom extends in a front direction is defined as the front.

The processing device 7 synthesizes a bird's-eye view image of the crane 1 and a periphery thereof viewed from above from images from the plurality of cameras 6 and uses the bird's-eye view image as a periphery monitoring image. The processing device 7 may be configured to generate a monitoring image in which images of the front, the rear, the left, and the right of the crane 1 are respectively displayed in a plurality of sections from the images from the plurality of cameras 6.

### Configuration of Disposition of Side Camera

The side cameras 61 and 62 are supported by the upper structure 31. More specifically, the side cameras 61 and 62 are supported by the left and right machine rooms 311a and 311b via brackets 611 and 621 (corresponding to support structures, see FIGS. 1C and 3C). The brackets 611 and 621 are attached to upper portions of the machine rooms 311a and 311b, and the side cameras 61 and 62 are fixed to the brackets 611 and 621.

The side cameras 61 and 62 can be disposed at a first position P1a on a left side and a first position P1b on a right side outside a range of the transport posture width W1 of the upper structure 31 (that is, shifted in the left-right direction from the range of the transport posture width W1), respectively.

With the above configuration, when the periphery of the crane 1 is monitored during work of the crane 1, the above disposition is applied, and thus the side cameras 61 and 62 can acquire images with a small blind spot on the left and the right of the crane 1. In particular, blind spots on the left and the right of the counterweight 32 are reduced, and thus the side cameras 61 and 62 can efficiently acquire peripheral images. The idea of performing camera disposition in consideration of the transport posture width W1 is not described in the related art. Accordingly, in the related art, it can be considered that the transport posture width is set to include a portion where the camera is disposed. That is, in such a configuration, an installation position for the camera is limited to the transport posture width as a result. Therefore, in a case where the counterweight is wider than the transport posture width, the blind spot of the camera becomes larger.

The side cameras 61 and 62 can be further changed in disposition to a second position P2a on the left side and a second position P2b on the right side included in the range of the transport posture width W1. More specifically, the side cameras 61 and 62 can be changed in disposition without being separated from the brackets 611 and 621, which are the support structures. That is, the side cameras 61 and 62 can be changed in disposition from the first positions P1a and P1b to the second positions P2a and P2b without being separated from the upper structure 31. The side cameras 61 and 62 are disposed at the second positions P2a and P2b during transport or the like of the crane 1. In this manner, an increase in the width of the transported configuration 5 including the upper structure 31 can be suppressed within the transport posture width W1 of a portion excluding the side cameras 61 and 62 while the side cameras 61 and 62 are supported by the upper structure 31. Therefore, the side cameras 61 and 62 are not obstructions during transport. In addition, in a case where the transport posture width W1 of the portion excluding the side cameras 61 and 62 is close to the maximum width determined by the regulations related to transport, a situation where the maximum width is exceeded by the side cameras 61 and 62 can be avoided. In addition, since the side cameras 61 and 62 are changed in disposition without being separated from the brackets 611 and 621, which are the support structures, it is not necessary to remove the side cameras 61 and 62 in work for changing from a posture during crane work to the transport posture. Accordingly, the work man-hours can be reduced.

As shown in FIGS. 1C and 3C, the brackets 611 and 621 include, in a part thereof, pivotable hinges a1 and a2 and locking structures b1 and b2 that lock pivoting positions via the hinges a1 and a2. The side cameras 61 and 62 can be respectively changed in disposition to the first positions P1a and P1b and the second positions P2a and P2b by pivoting the brackets 611 and 621 via the hinges a1 and a2 and locking with the locking structures b1 and b2. The hinges a1 and a2 of the first embodiment are configured to be pivotable in a direction around a vertical axis.

The side cameras 61 and 62 are supported by the brackets 611 and 621 such that centers of angles of view of the side cameras 61 and 62 at the first positions P1a and P1b face 90 degrees to the left and 90 degrees to the right from a center line A0 in the front-rear direction (see FIG. 1C) in plan view.

Detailed Disposition in Front-Rear Direction of First Positions P1a and P1b

As shown in FIG. 1C, in plan view, the first positions P1a and P1b are set to overlap a reference band-shaped region H1 extending in the left-right direction through a rotation center O1 of the upper structure 31. The reference band-shaped region H1 means a region in which a band having a predetermined width extends in a linear shape, and the width of the band (a length in the front-rear direction) is defined as 10 cm. According to the definition, when a front end of the reference band-shaped region H1 overlaps the rotation center O1, a case where the first positions P1a and P1b overlap a rear end of the reference band-shaped region H1 is a case where the first positions P1a and P1b are set furthest rearward. In addition, when the rear end of the reference band-shaped region H1 overlaps the rotation center O1, a case where the first positions P1a and P1b overlap the front end of the reference band-shaped region H1 is a case where the first positions P1a and P1b are set furthest forward. The reason why the width is provided at the position as described above is due to design errors and because a difference in effect is not large in a case of an error of approximately 10 cm.

According to the setting, when the upper structure 31 is rotated, left and right images of the upper structure 31 captured by the left and right side cameras 61 and 62 are symmetric images with the rotation center O1 as reference. Therefore, in a case where the images are used for synthesizing a bird's-eye view image, the bird's-eye view image is easily synthesized, and portions of images from the side cameras 61 and 62, which are extended in the bird's-eye view image, are symmetric in the front-rear direction, and thus a natural bird's-eye view image can be obtained.

### Detailed Disposition in Left-Right Direction of First Positions P1a and P1b

As shown in FIG. 1B, the first positions P1a and P1b are preferably set to be closer to left and right ends q2a and q2b of the counterweight 32 than left and right ends q1a and q1b of the transport posture width W1, respectively, in the left-right direction of the upper structure 31. Accordingly, a blind spot in the periphery of the crane 1 generated by the counterweight 32 (a blind spot E4 to be described later) can be further reduced. Further, in a case where the first positions P1a and P1b are positioned outside the left and right ends q2a and q2b of the counterweight 32 in the left-right direction of the upper structure 31, it is preferable that the first positions P1a and P1b are set to be positioned within a range of 20 cm in the left-right direction from the left and right ends q2a and q2b. In addition, it is preferable that the first positions P1a and P1b are set to overlap the undercarriage 21 (more specifically, a crawler belt) in plan view. With such a setting, the blind spot (a blind spot E2 to be described later) outside the undercarriage 21 on the left and the right can be further reduced.

As shown in FIGS. 1A and 1B, the front camera 64, the rear camera 63, and the side cameras 61 and 62 are positioned above the machine rooms 311a and 311b. Furthermore, the front camera 64, the rear camera 63, and the side cameras 61 and 62 are positioned below an upper surface of the cab 312. That is, the front camera 64, the rear camera 63, and the side cameras 61 and 62 are positioned at substantially the same height. In this manner, height positions of the cameras are set to be positions close to each other such that each of the cameras is positioned at substantially the same height, and thus distortion of images when images from the cameras are synthesized can be reduced.

According to the setting, a blind spot in the periphery of the crane 1 can be further reduced in images obtained by the side cameras 61 and 62.

### Comparison of Blind Spots Generated in Image

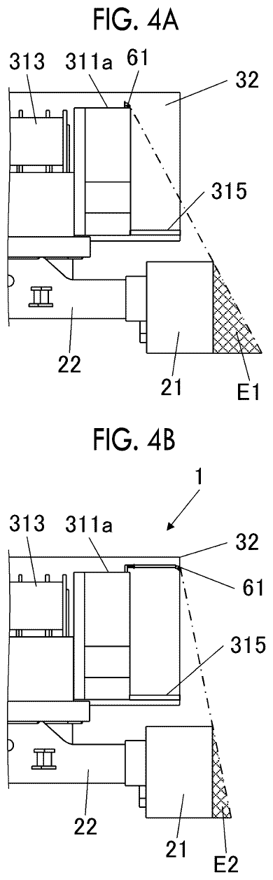

FIGS. 4A and 4B are views showing a blind spot when viewed from a front side in the first embodiment and a comparative example. FIGS. 4C and 4D are views showing the blind spot viewed from above in the first embodiment and the comparative example. The comparative example corresponds to a configuration where the left and right side cameras 61 and 62 are positioned at the left and right ends of the upper structure 31 in the range of the transport posture width W1. As shown in FIGS. 4A and 4B, the blind spot E2 of the configuration of the first embodiment is smaller than a blind spot E1 of the comparative example in a region near the outside of the undercarriage 21 of the lower traveling body 2 on the left and right. In addition, the blind spot of the undercarriage 21 in the front-rear direction is also smaller in the configuration of the first embodiment than in the comparative example. In addition, as shown in FIGS. 4C and 4D, the blind spot E4 of the configuration of the first embodiment is smaller than a blind spot E3 of the comparative example on the rear left and right of the counterweight 32. In FIGS. 4C and 4D, hatched regions D1 to D3 indicate imaging regions of the left and right side cameras 61 and 62 and the rear camera 63, and regions of the blind spots E3 and E4 are indicated by a mesh pattern. The blind spot E2 outside the undercarriage 21 on the left and the right may be called a side blind spot E2, and the blind spot E4 on left and right rear sides of the counterweight 32 may be called a rear blind spot E4.

### Bird's-Eye View Image

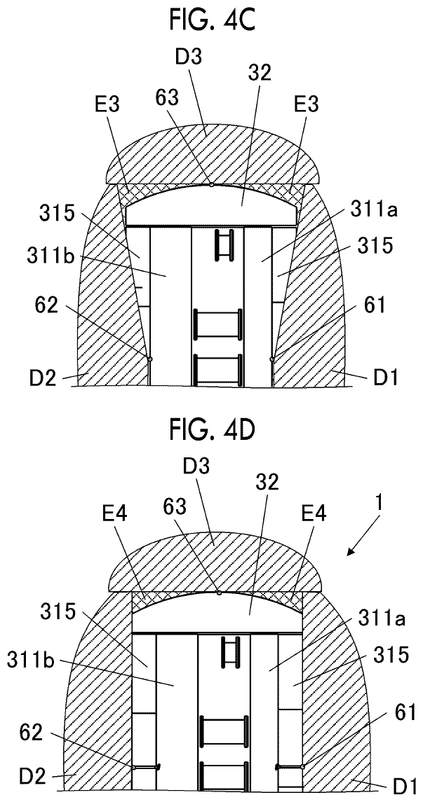

FIG. 5 is a view showing an example of a bird's-eye view image synthesized from images from the plurality of cameras including the two side cameras. As shown in FIG. 5, the processing device 7 can generate a bird's-eye view image by synthesizing images from the left and right side cameras 61 and 62 and images from the front camera 64 and the rear camera 63. In the bird's-eye view image, an image of the crane 1 is positioned at the center, and in a periphery thereof, images in which a part of images from the cameras 61 to 64 is extended in a predetermined pattern and another part is contracted are positioned. With such a bird's-eye view image, the worker can accurately identify the situation in the periphery of the crane 1. In the present embodiment, the bird's-eye view image can be generated with a small number of images from the cameras 61 to 64, and a region E that is an image blind spot in the bird's-eye view image is reduced.

### When Left and Right Overhang Amounts of Counterweight Are Different

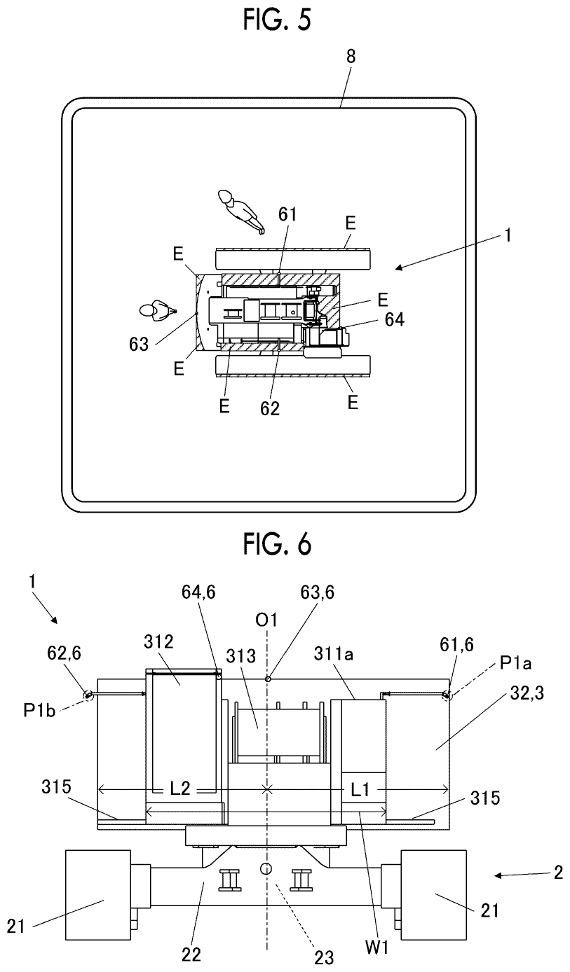

FIG. 6 is a view showing an example of setting the first positions P1a and P1b when the overhang amount of the counterweight is different. The fact that the overhang amount of the counterweight is different indicates that the length of the counterweight when viewed from the front of the upper structure 31 is different between a length from the rotation center O1 to the left end of the counterweight (a left overhang amount of the counterweight) and a length from the rotation center O1 to the right end of the counterweight (a right overhang amount of the counterweight). In this example, when viewed from the front of the upper structure 31, a distance L1 from the rotation center O1 to the left end of the counterweight 32 is longer than a distance L2 from the rotation center O1 to the right end of the counterweight 32.

In the case of this configuration, in the left-right direction, it is preferable that the first position P1a on the left (first side) is positioned closer to the center than the left end of the counterweight 32, and that the first position P1b on the right (second side) is positioned outside the right end of the counterweight 32. According to the disposition, an effect is achieved that both an operation of reducing a blind spot (a lateral blind spot of the counterweight 32) in images from the left and right side cameras 61 and 62 and an operation capable of generating a bird's-eye view image in which left and right images are symmetric with respect to the rotation center O1 and have less incongruity are obtained in a well-balanced manner. When the lengths of the distances L1 and L2 are reversed, the setting of the disposition of the first positions P1a and P1b may also be a setting obtained by reversing the above setting left and right.

The crane 1 of the first embodiment has been described hereinbefore. The crane 1 according to the present invention is not limited to the first embodiment above. For example, in the crane 1 of the first embodiment, an example in which the two side cameras 61 and 62 that image the side are provided on the left and the right among the plurality of cameras 6 that image the periphery is shown. However, the number of the side cameras is not limited, and four side cameras that image the side may be provided. In addition, the rear camera 63 and the front camera 64 may not be provided, or a configuration where images of the side cameras 61 and 62 are not used in order to create a bird's-eye view image, and the captured images are displayed in a state close thereto may be adopted. Further, in the first embodiment, a configuration where the side cameras 61 and 62 can be changed in disposition between the first positions P1a and P1b and the second positions P2a and P2b by pivoting the brackets 611 and 621 is shown. However, various configurations capable of causing a change in disposition, such as a slide mechanism, a link mechanism, and a mechanism in which sliding and pivoting are combined with each other, can be applied. In addition to an aspect in which the change in disposition can be made without being separated from the support structures, the side camera 61 or the bracket thereof may be configured to be attached at two locations of the upper structure 31 and to be removable, and the side camera 61 may be capable of being changed in disposition by removing and moving the side camera 61 or the bracket thereof from one of the two locations to the other location. In a case where the side camera 61 is removed and is changed in disposition, a second position after the change in disposition where the side cameras 61 and 62 are attached may be a position of a component other than the transported configuration 5, more specifically, a component other than the rotating platform 3 (for example, the undercarriage 21 or the like). Also in this case, the transported configuration 5 can be transported in a state where the cameras are removed. A configuration of the side camera 61 shown in the present paragraph can be similarly applied to the other side camera 62.

### Second Embodiment

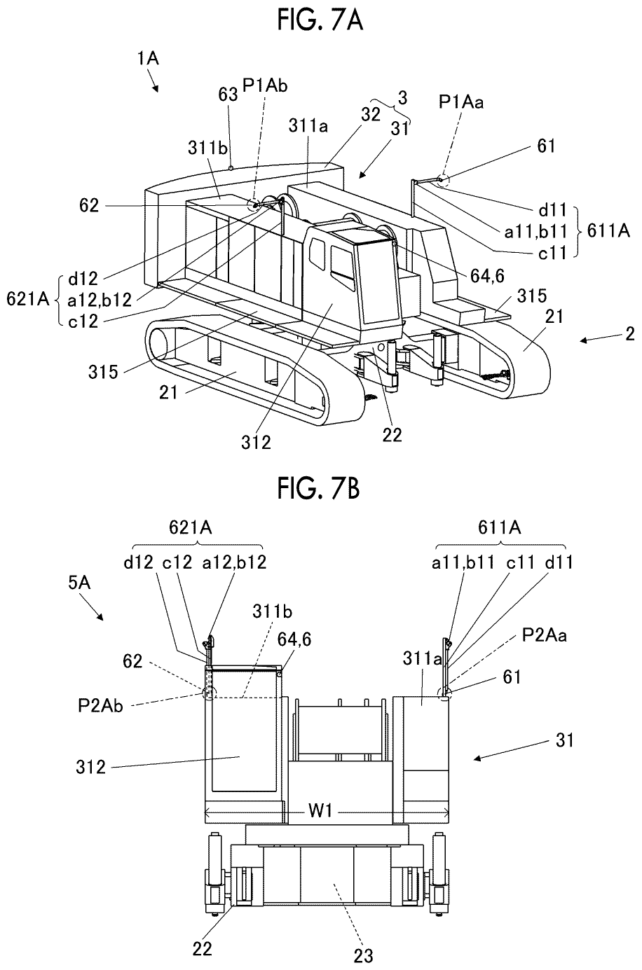

FIGS. 7A and 7B are a perspective view of a crane according to the second embodiment of the present invention and a front view of a transported configuration thereof. A crane 1A of the second embodiment is different in terms of the support structures of the side cameras 61 and 62 and disposition of first positions P1Aa and P1Ab in the up-down direction, but other elements are substantially the same as in the first embodiment. Hereinafter, different configurations will be described in detail.

The side cameras 61 and 62 are supported by the upper structure 31. More specifically, the side cameras 61 and 62 are supported by the left and right machine rooms 311a and 311b via brackets 611A and 621A. The brackets 611A and 621A are attached to the upper portions of the machine rooms 311a and 311b, and the side cameras 61 and 62 are fixed to the brackets 611A and 621A.

The side cameras 61 and 62 can be disposed at the first position P1Aa on the left side and the first position P1Ab on the right side, respectively, outside the range of the transport posture width W1 of the upper structure 31.

With the above configuration, when the periphery of the crane 1A is monitored during work of the crane 1A, blind spots of the side cameras 61 and 62 can be reduced on the left and the right of the crane 1A with the above disposition. In particular, the blind spots on the left and the right of the counterweight 32 are reduced (see FIGS. 4C and 4D), and thus a peripheral image can be efficiently acquired.

Furthermore, as shown in FIG. 7B, the side cameras 61 and 62 can be disposed at a second position P2Aa on the left side and a second position P2Ab on the right side within the range of the transport posture width W1. More specifically, the side cameras 61 and 62 are configured to be capable of being changed in disposition described above without being separated from the brackets 611A and 621A, which are the support structures. That is, the side cameras 61 and 62 can be changed in disposition from the first positions P1Aa and P1Ab to the second positions P2Aa and P2Ab without being separated from the upper structure 31. The side cameras 61 and 62 are disposed at the second positions P2Aa and P2Ab during transport or the like of the crane 1A. In this manner, an increase in the width of a transported configuration 5A including the upper structure 31 can be suppressed within the transport posture width W1 of a portion excluding the side cameras 61 and 62 while the side cameras 61 and 62 are supported. Therefore, the side cameras 61 and 62 are not obstructions during transport. In addition, in a case where the transport posture width W1 of the portion excluding the side cameras 61 and 62 is close to the maximum width determined by the regulations related to transport, a situation where the maximum width is exceeded by the side cameras 61 and 62 can be avoided.

The brackets 611A and 621A include pillars c11 and c12, arms d11 and d12, hinges a11 and a12 that pivotably connect the arms d11 and d12 to the pillars c11 and c12, and locking structures b11 and b12 that lock pivoting positions via the hinges a11 and a12. The pillars c11 and c12 are fixed to the upper structure 31, and the side cameras 61 and 62 are attached to the arms d11 and d12. The side cameras 61 and 62 can be respectively changed in disposition to the first positions P1Aa and P1Ab and the second positions P2Aa and P2Ab by pivoting the arms d11 and d12 via the hinges a11 and a12 and locking with the locking structures b11 and b12. The hinges a11 and a12 of the second embodiment are configured to be pivotable in a direction around an axis extending in the front-rear direction. The arms d11 and d12 are pivotable from a state where a longitudinal direction faces the up-down direction to a state where the longitudinal direction faces the left-right direction.

When the arms d11 and d12 are open in the left-right direction and the side cameras 61 and 62 are at the first positions P1Aa and P1Ab, the directions of the side cameras 61 and 62 may be determined such that the centers of angles of the side cameras 61 and 62 face 90 degrees to the left and 90 degrees to the right from the center line A0 in the front-rear direction in plan view.

The same operation and effect as those of the first embodiment are obtained by the crane 1A of the second embodiment. Furthermore, with the crane 1A of the second embodiment, the first positions P1Aa and P1Ab can be easily set at high positions. Therefore, when the side cameras 61 and 62 are in a use state, the side cameras 61 and 62 are positioned above and away from the worker walking on the catwalk 315, and an effect in which the worker is less likely to be hindered in walking is achieved. In addition, since the side cameras 61 and 62 can image the left and right sides from high positions, an effect in which a lateral blind spot of the undercarriage 21 can be reduced is achieved. A configuration where the arms d11 and d12 pivot from a state where the longitudinal direction faces the up-down direction to a state where the longitudinal direction faces the left-right direction can be applied to various configurations, such as a configuration where the arms d11 and d12 pivot around a rotary shaft extending in the front-rear direction, a configuration where the arms d11 and d12 pivot in a plurality of stages in a way in which the arms d11 and d12 pivot once such that the longitudinal direction extends forward and then pivot such that the longitudinal direction extends in the left-right direction, and a configuration where the arms d11 and d12 are pivotable in a free direction like a universal joint.

### Third Embodiment

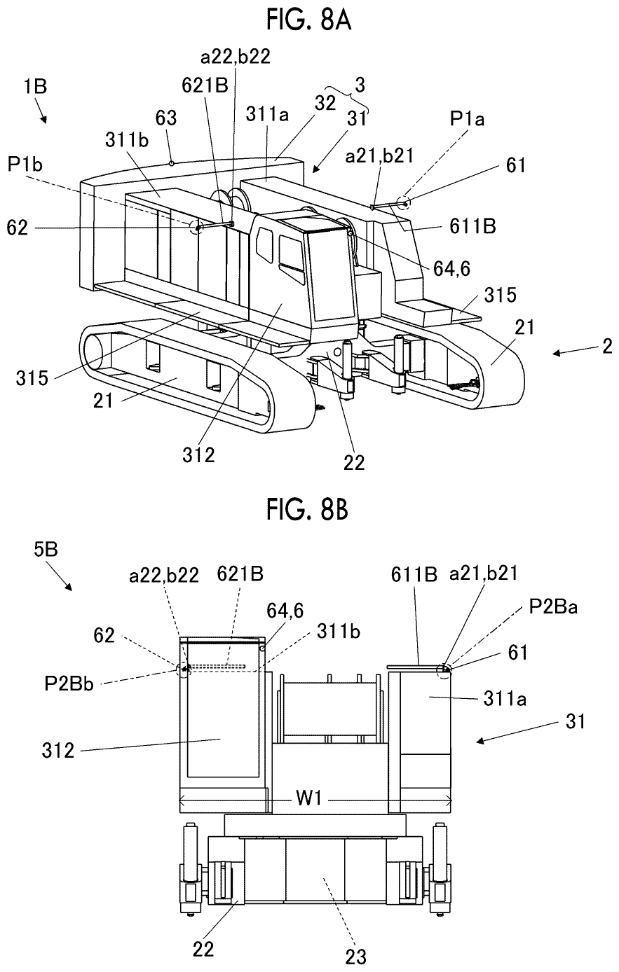

FIGS. 8A and 8B are a perspective view of a crane according to the third embodiment of the present invention and a front view of a transported configuration thereof. A crane 1B of the third embodiment is mainly different in terms of the support structures of the side cameras 61 and 62, but other elements are substantially the same as in the first embodiment. Hereinafter, different configurations will be described in detail.

The side cameras 61 and 62 are supported by the upper structure 31. More specifically, the side cameras 61 and 62 are supported by the left and right machine rooms 311a and 311b via brackets 611B and 621B. The brackets 611B and 621B are attached to the upper portions of the machine rooms 311a and 311b, and the side cameras 61 and 62 are fixed to the brackets 611B and 621B.

The side cameras 61 and 62 can be disposed at the first position P1a on the left side and the first position P1b on the right side, respectively, outside the range of the transport posture width W1 of the upper structure 31.

With the above configuration, when the periphery of the crane 1B is monitored during work of the crane 1B, blind spots of the side cameras 61 and 62 can be reduced on the left and the right of the crane 1B with the above disposition. In particular, the blind spots on the left and the right of the counterweight 32 are reduced, and thus a peripheral image can be efficiently acquired.

As shown in FIG. 8B, the side cameras 61 and 62 can be changed in disposition to a second position P2Ba on the left side and a second position P2Bb on the right side included in the range of the transport posture width W1. More specifically, the side cameras 61 and 62 are configured to be capable of being changed in disposition described above without being separated from the brackets 611B and 621B, which are the support structures (that is, without being separated from the upper structure 31). The side cameras 61 and 62 are disposed at the second positions P2Ba and P2Bb during transport or the like of the crane 1B. In this manner, an increase in the width of a transported configuration 5B including the upper structure 31 can be suppressed within the transport posture width W1 of a portion excluding the side cameras 61 and 62 while the side cameras 61 and 62 are supported. Therefore, the side cameras 61 and 62 are not obstructions during transport. In addition, in a case where the transport posture width of the portion excluding the side cameras 61 and 62 is close to the maximum width determined by the regulations related to transport, a situation where the maximum width is exceeded by the side cameras 61 and 62 can be avoided.

The brackets 611B and 621B include slide mechanisms a21 and a22 and locking structures b21 and b22 that lock the slide positions of the slide mechanisms a21 and a22. The brackets 611B and 621B slide in the left-right direction via the slide mechanisms a21 and a22, and the brackets 611B and 621B are locked when sliding outward in the left-right direction. In this manner, the side cameras 61 and 62 are fixed to the first positions P1a and P1b. In addition, the brackets 611B and 621B slide in the left-right direction via the slide mechanisms a21 and a22, and the brackets 611B and 621B are locked when sliding inward in the left-right direction. In this manner, the side cameras 61 and 62 are fixed to the second positions P2Ba and P2Bb.

The same operation and effect as those of the first embodiment are obtained by the crane 1B of the third embodiment.

### Fourth Embodiment

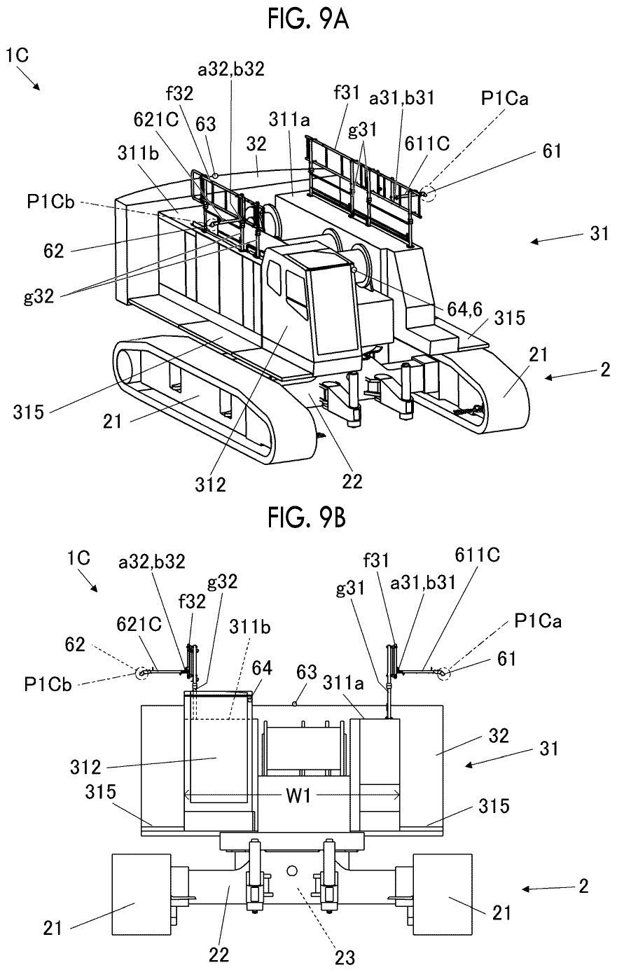

FIGS. 9A and 9B are a perspective view and a front view showing a crane according to the fourth embodiment of the present invention. FIGS. 10A and 10B are a perspective view and a front view showing a transported configuration of the crane according to the fourth embodiment of the present invention. A crane 1C of the fourth embodiment is different in terms of the support structures of the side cameras 61 and 62 and disposition of first positions P1Ca and P1Cb in the up-down direction, but other elements are substantially the same as in the first embodiment. Hereinafter, different configurations will be described in detail.

The side cameras 61 and 62 are supported by the upper structure 31. More specifically, a handrail f31 is provided outside the left machine room 311a and near an upper left end thereof, and a handrail f32 is provided near an upper right end of the right machine room 311b. A portion of the handrails f31 and f32 is configured to be slidable (movable up and down) in an upward direction with respect to pillars g31 and g32 fixed to the machine rooms 311a and 311b and to be lockable at a slide position. That is, the handrails f31 and f32 of which heights can be changed to a first height and a second height are provided above the upper structure 31. The second height is a height lower than the first height. Accordingly, the height during transport can be reduced. The side cameras 61 and 62 are attached to the handrails f31 and f32 via brackets 611C and 621C. The handrails f31 and f32 are configured to be movable up and down together with the side cameras 61 and 62. Accordingly, the configuration for a change in disposition of the side cameras 61 and 62 in the up-down direction and the configuration for switching between a use position and a non-use position of the handrails f31 and f32 can be reused. In addition, the side cameras 61 and 62 are slidable in the upward direction (movable up and down) by the handrails f31 and f32 being partially moved up and down. However, the side cameras may be movable up and down independently of a portion of the handrails f31 and f32. In addition, the entire handrails f31 and f32 may be folded inward in the left-right direction. In this case, the height during transport can be further reduced.

Herein, the movement of an assembly worker will be described with regard to a change in disposition of the side cameras 61 and 62 when the crane 1C is switched from the transport posture to a work posture in which a load can be hung, with reference to FIGS. 9A to 10B. First, the assembly worker climbs onto the machine rooms 311a and 311b of the crane 1C in the transport posture. In this case, the handrails f31 and f32 are switched to the use position. In this case, the brackets 611C and 621C of the side cameras 61 and 62 disposed at a second position P2Ca on the left side and a second position P2Cb on the right side within the range of the transport posture width W1 are fixed to the handrails f31 and f32 on a side of the side cameras 61 and 62 (that is, one side). Specifically, one side of the handrails f31 and f32 and one side of the brackets 611C and 621C are respectively fixed by a fixing pin. In a state of riding on the machine rooms 311a and 311b, the assembly worker removes the fixing pin and then pivots the brackets 611C and 621C to change the side cameras 61 and 62 in disposition to the first position P1Ca on the left side and the first position P1Cb on the right side, respectively. Then, the side of the side cameras 61 and 62 is fixed to the first position P1Ca on the left side and the first position P1Cb on the right side by a locking mechanism on the other side (that is, handrail f31 and f32 side) of the brackets 611C and 621C. In this case, the locking mechanism may be a fixing pin or may be various mechanisms such as a lock bolt. When the assembly worker changes the work posture to the transport posture, the assembly worker performs the reverse operation.

The side cameras 61 and 62 can be disposed at the first position P1Ca on the left side and the first position P1Cb on the right side, respectively, outside the range of the transport posture width W1 of the upper structure 31.

With the above configuration, when the periphery of the crane 1C is monitored during work of the crane 1C, blind spots of the side cameras 61 and 62 can be reduced on the left and the right of the crane 1C with the above disposition. In particular, the blind spots on the left and the right of the counterweight 32 are reduced, and thus a peripheral image can be efficiently acquired.

Furthermore, as shown in FIG. 10B, the side cameras 61 and 62 can be disposed at the second position P2Ca on the left side and the second position P2Cb on the right side within the range of the transport posture width W1. More specifically, the side cameras 61 and 62 are configured to be capable of being changed in disposition described above without being separated from the brackets 611C and 621C, which are the support structures, and the handrails f31 and f32 (that is, without being separated from the upper structure 31). Furthermore, the side cameras 61 and 62 can be disposed at the second positions P2Ca and P2Cb in a state where the heights of the handrails f31 and f32 are set to the second height. The side cameras 61 and 62 are disposed at the second positions P2Ca and P2Cb during transport or the like of the crane 1C. In this manner, an increase in the width of a transported configuration 5C including the upper structure 31 can be suppressed within the transport posture width W1 of a portion excluding the side cameras 61 and 62 while the side cameras 61 and 62 are supported. Therefore, the side cameras 61 and 62 are not obstructions during transport. In addition, in a case where the transport posture width W1 of the portion excluding the side cameras 61 and 62 is close to the maximum width determined by the regulations related to transport, a situation where the maximum width is exceeded by the side cameras 61 and 62 can be avoided.

As shown in FIGS. 9A and 9B, the front camera 64, the rear camera 63, and the side cameras 61 and 62 are positioned above the machine rooms 311a and 311b. Furthermore, the front camera 64, the rear camera 63, and the side cameras 61 and 62 are positioned below upper surfaces of the handrails f31 and f32. Furthermore, the front camera 64 is positioned at a height closer to the upper surface of the cab 312 than the upper surfaces of the machine rooms 311a and 311b. Furthermore, the rear camera 63 is positioned at a height closer to the height of the front camera 64 than the upper surfaces of the machine rooms 311a and 311b. That is, the front camera 64, the rear camera 63, and the side cameras 61 and 62 are positioned at substantially the same height. In this manner, height positions of the cameras are set to be positions close to each other such that each of the cameras is positioned at substantially the same height, and thus distortion of images when images from the cameras are synthesized can be reduced.

The brackets 611C and 621C include, in a part thereof, pivotable hinges a31 and a32 and locking structures b31 and b32 that lock pivoting positions via the hinges a31 and a32. The side cameras 61 and 62 can be respectively changed in disposition to the first positions P1Ca and P1Cb and the second positions P2Ca and P2Cb by pivoting the brackets 611C and 621C via the hinges a31 and a32, locking with the locking structures b31 and b32, and moving the handrails f31 and f32 up and down. The hinges a31 and a32 of the fourth embodiment are configured to be pivotable in a direction around a vertical axis. The brackets 611C and 621C are not limited to the above structure insofar as movement including components in the left-right direction can be made, and for example, the structures of the second and third embodiments may be applied.

The side cameras 61 and 62 are supported by the brackets 611C and 621C such that centers of angles of view of the side cameras 61 and 62 at the first positions P1Ca and P1Cb face 90 degrees to the left and 90 degrees to the right from the center line A0 in the front-rear direction in plan view.

The same operation and effect as those of the first embodiment are obtained by the crane 1C of the fourth embodiment. Furthermore, with the crane 1C of the fourth embodiment, the first positions P1Ca and P1Cb can be easily set at high positions by moving the handrails f31 and f32 up and down. Therefore, when the side cameras 61 and 62 are in a use state, the side cameras 61 and 62 are positioned above and away from the worker walking on the catwalk 315, and an effect in which the worker is less likely to be hindered in walking is achieved. In addition, since the side cameras 61 and 62 can image the left and right sides from high positions, for example, an effect in which a lateral blind spot of the undercarriage 21 can be reduced is achieved. In addition, since the heights of the side cameras 61 and 62 can be changed by utilizing the up and down movement of the handrails f31 and f32, a structure for changing the positions of the side cameras 61 and 62 can be simplified. Accordingly, the height during transport of the crane can be prevented from greatly deviating from the height of the upper structure 31, and an increase in the height of the transported configuration 5C can be suppressed.

Heretofore, each of the embodiments of the present invention has been described. However, the present invention is not limited to the embodiments. For example, a crawler crane has been described as an example of the crane according to the present invention in the embodiments described above. However, without being limited thereto, other mobile cranes such as a wheel crane, a truck crane, a rough terrain crane, and an all-terrain crane may be used. In addition, the crane according to the present invention may be various mobile cranes and various non-mobile cranes insofar as the crane includes the counterweight and the upper structure and includes the transported configuration including the upper structure. In addition, details shown in the embodiments can be changed as appropriate without departing from the gist of the invention.

The present invention can be used for a crane.

It should be understood that the invention is not limited to the above-described embodiment, but may be modified into various forms on the basis of the spirit of the disclosure. Additionally, the modifications are included in the scope of the disclosure.

What is claimed is:

1. A crane comprising:
a counterweight;
an upper structure behind which the counterweight is disposed, in which a transport posture width of a transported configuration including the upper structure is smaller than a width of the counterweight; and
at least two side cameras that image a left-right direction from the upper structure,
wherein the two side cameras are disposed at a first position on a left side and a first position on a right side, respectively, outside a range of the transport posture width, and
the two side cameras are changeable in disposition to a second position on the left side and a second position on the right side, respectively, which are different from the first position on the left side and the first position on the right side.

2. The crane according to claim 1, the crane being a self-traveling crawler crane, further comprising:
a lower traveling body configured to travel;
a rotating platform that includes the upper structure and the counterweight, and is provided to be rotatable with respect to the lower traveling body;
a boom and a mast that are assembled to the rotating platform to be derricked;
a hanging tool hung by the boom; and
a wire rope that is configured to be wound and unwound by a winch.

3. The crane according to claim 2,
wherein the lower traveling body includes an undercarriage, a frame that supports the undercarriage, and a rotating portion that supports the rotating platform to be rotatable, and
when a front surface of the rotating platform is directed toward a straight traveling direction of the undercarriage, a width of the undercarriage is wider than a width of the rotating platform.

4. The crane according to claim 1,
wherein the crane is disassembled into a plurality of transported configurations respectively including the upper structure, a frame of a lower traveling body, and a rotating portion, is transported by a transport machine, and is assembled on a site.

5. The crane according to claim 4,
wherein the transported configuration is designed such that the transport posture width is close to a maximum width determined by regulations related to transport when traveling on a public road while being placed on the transport machine.

6. The crane according to claim 1, further comprising:
a periphery monitoring device that includes a plurality of cameras including the two side cameras and that image a periphery of a machine body, a processing device that captures images from the plurality of cameras to generate an image for surroundings monitoring, and a display that outputs the image for surroundings monitoring generated by the processing device.

7. The crane according to claim 1,
wherein the left and right second positions are positioned within the range of the transport posture width of the transported configuration.

8. The crane according to claim 7,
wherein the two side cameras are changeable in disposition from the first positions to the second positions without being separated from the upper structure.

9. The crane according to claim 8,
wherein the upper structure includes, above the upper structure, a handrail of which a height is changeable to a first height and a second height lower than the first height, and
the side cameras are supported by the handrail and are configured to be disposed at the second positions in a state where the height of the handrail is set to the second height.

10. The crane according to claim 9,
wherein the handrail is configured to be moved up and down together with the side cameras.

11. The crane according to claim 1,
wherein the left and right first positions are closer to left and right ends of the counterweight than left and right ends of the transport posture width, respectively, in the left-right direction of the upper structure.

12. The crane according to claim 1,
wherein when one side and the other side of the left-right direction are called a first side and a second side,
in plan view, a distance from a center line passing through a rotation center of the upper structure and extending in a front-rear direction to an end of the counterweight on the first side is longer than a distance from the center line to an end of the counterweight on the second side,
in the left-right direction of the upper structure, the first position on the first side is positioned on a center line side of the end of the counterweight on the first side, and
in the left-right direction of the upper structure, the first position on the second side is positioned outside the end of the counterweight on the second side.

13. The crane according to claim 1,
wherein in plan view, the two side cameras at the left and right first positions overlap a reference band-shaped region passing through a rotation center of the upper structure and extending in the left-right direction.

14. The crane according to claim 1, further comprising:
one or a plurality of cameras that image surroundings of the upper structure and the counterweight; and
a processing device that synthesizes a bird's-eye view image of the crane based on images from the two side cameras and the one or the plurality of cameras.
